(19) United States
(12) Patent Application Publication
(10) Pub. No.: US 2004/0233379 A1
(43) Pub. Date: Nov. 25, 2004

(54) Liquid crystal display and manufacturing method thereof

(76) Inventors: Tomoatsu Kinoshita, Kanagawa (JP); Akihiko Asano, Kanagawa (JP); Natsuki Otani, Kanagawa (JP); Takayuki Hatanaka, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/781,034

(22) Filed: Feb. 18, 2004

(30) Foreign Application Priority Data
Feb. 18, 2003 (JP) P2003-039101
Jan. 30, 2004 (JP) P2004-022570

(51) Int. Cl. G02F 1/1333

(52) U.S. Cl. 349/158

(57) ABSTRACT

A liquid crystal display includes a first substrate made up of a plastic substrate on which a first electrode for driving liquid crystal is formed, a second substrate made up of a plastic substrate on which a second electrode for driving liquid crystal is formed, and a liquid crystal layer held between the first and second substrates. At least one of the first and second substrates is a plastic substrate. The first and second substrate are glued together, and then the glued substrates are cut out into panels employing laser cutting. An opening for passing through either the first or second substrate is formed on a portion serving as a liquid crystal inlet prior to gluing the first and second substrates, and a notched portion in which at least a part of the opening is employed, is formed on a portion serving as the liquid crystal inlet of the panel.

### BACKGROUND OF THE INVENTION

1. Field of the Invention

The present invention relates to a method for manufacturing a liquid crystal display and a liquid crystal display, and more particularly relates to a method for manufacturing a liquid crystal display with improved yield by reducing unsuitable liquid crystal injection in a liquid crystal injection process when manufacturing a liquid crystal display employing a plastic substrate and the liquid crystal display.

2. Description of the Related Art

In general, in order to manufacture a liquid crystal display, transparent electrodes, orientation films, and other necessary thin-film layers, which are equivalent to multiple panels, are formed on a pair of substrates, following which a ringed seal member is formed on a portion of either one of the pair of substrates except a portion serving as a liquid crystal inlet, following which spacers are dispersed on either one of the pair of substrates for keeping a gap between the pair of substrates when the pair of substrates are glued together. Subsequently, the pair of substrates is glued together, following which the glued pair of substrates is cut out into liquid crystal cells in the size of a panel. Subsequently, liquid crystal is injected from the liquid crystal inlet into the liquid crystal cell, and then the above-described liquid crystal inlet is sealed with a molded resin, thereby completing a liquid crystal display.

Currently, glass substrates or quartz substrates are primarily employed for substrates. However, in recent years, the development of liquid crystal displays employing a plastic substrate is processing in order to meet the needs of reduction in size, thickness, weight, and increased robustness. With the glass substrates, in general, when cutting a pair of substrates in a process for manufacturing a liquid crystal display, following scribing the glass substrate employing a diamond cutter, mechanical impact is applied to the scribed glass substrate so as to cut out the glass substrate. With this cutting method, the fragility of glass properties is utilized, so this method is not readily applied to plastic substrates which do not fracture due to inherent fragility. Accordingly, as a method for cutting plastic substrates, cutting with a linear blade, a rotary blade, a laser beam, and the like is under study.

However, with liquid crystal displays, it is highly possible that thin-film layers may be subjected to damage since cutting by a blade imposes strong mechanical impact. On the other hand, cutting by a laser beam melts the substrate by heat without providing mechanical force onto the substrate, so thin-film layers are subjected to little damage. Thus, in a case of cutting plastic substrates of liquid crystal displays, it is considered that cutting by a laser beam is most suitable (see Japanese Unexamined Patent Application Publication No. 6-342139, for example).

With the laser cutting method, a pair of plastic substrates is melted by heat of laser irradiation when cutting out the pair of the plastic substrates into multiple liquid crystal displays, so a phenomenon in which the pair of plastic substrates is fused at cross-section thereof sometimes occurs.

This causes a problem, which to be solved in the present invention, in that in the event that this fusing occurs at the liquid crystal inlet, liquid crystal injection cannot be performed, or even in the event that liquid crystal injection can be performed air bubbles are injected into liquid crystal being injected since the injection speed of liquid crystal slow downs.

### SUMMARY OF THE INVENTION

Accordingly, it is an object of the present invention to provide a method for manufacturing a liquid crystal display with improved yield by reducing unsatisfactory liquid crystal injection in a liquid crystal injection process when manufacturing a liquid crystal display employing a plastic substrate and the liquid crystal display.

With a first liquid crystal display according to the present invention, the first liquid crystal display comprises a first substrate on which a first electrode for driving liquid crystal is formed; a second substrate on which a second electrode for driving liquid crystal is formed; and a liquid crystal layer held between the first and second substrates; wherein at least one substrate of the first and second substrates is a plastic substrate; wherein the first and second substrate are glued together, and then the glued first and second substrates are cut out into panels employing laser cutting; wherein an opening for passing through either the first or second substrate is formed on a portion serving as a liquid crystal inlet prior to gluing the first and second substrates; and wherein a notched portion in which at least a part of the opening is employed is formed on a portion serving as the liquid crystal inlet of the panel.

With a second liquid crystal display according to the present invention, the second liquid crystal display comprises a first substrate on which a first electrode for driving liquid crystal is formed; a second substrate on which a second electrode for driving liquid crystal is formed; and a liquid crystal layer held between the first and second substrates; wherein at least one substrate of the first and second substrates is a plastic substrate; wherein the first and second substrates are glued together, and then the glued first and second substrates are cut out into panels employing laser cutting; wherein an opening for passing through either the first or second substrate is formed on a portion serving as a liquid crystal inlet prior to gluing the first and second substrates; wherein at least a part of the opening is employed for a portion serving as a liquid crystal inlet of the panel; and wherein the panel is cut out in a state wherein the substrate on which the opening is not formed protrudes toward outside of the liquid crystal inlet from the substrate on which the opening is formed.

With a third liquid crystal display according to the present invention, the third liquid crystal display comprises a first substrate on which a first electrode for driving liquid crystal is formed; a second substrate on which a second electrode for driving liquid crystal is formed; and a liquid crystal layer held between the first and second substrates; wherein at least one substrate of the first and second substrates is a plastic substrate; wherein an extended portion protruding toward outside of the first and second substrates is formed; wherein a hole serving as a liquid crystal inlet is formed on at least one substrate region of the first substrate and the second substrate on the side of the extended portion, for passing through the substrate.

With a fourth liquid crystal display according to the present invention, the fourth liquid crystal display comprises a first substrate on which a first electrode for driving liquid crystal is formed; a second substrate on which a second electrode for driving liquid crystal is formed; and a liquid crystal layer held between the first and second substrates; wherein at least one substrate of the first and second substrates is a plastic substrate; and wherein a hole serving as a liquid crystal inlet passing through at least one substrate of the first and second substrates is formed on the substrate.

With a first method for manufacturing a liquid crystal display according to the present invention, the first method for manufacturing a liquid crystal display comprises a step for gluing a first substrate on which an electrode for driving liquid crystal is formed and a second substrate on which an electrode for driving liquid crystal is formed through a seal member which is formed on a portion other than a portion serving as a liquid crystal inlet, and then forming liquid crystal cells by cutting out the glued first and second substrates employing laser cutting, wherein at least one substrate of the first and second substrates is a plastic substrate; wherein an opening for passing through either the first or second substrate is formed on a portion serving as a liquid crystal inlet prior to cutting out the glued first and second substrates employing laser cutting; and wherein a notched portion in which at least a part of the opening is employed is formed on a portion serving as the liquid crystal inlet of the liquid crystal cell which is formed by cutting out the glued first and second substrates.

With a second method for manufacturing a liquid crystal display according to the present invention, the second method for manufacturing a liquid crystal display comprises a step for gluing a first substrate on which an electrode for driving liquid crystal is formed and a second substrate on which an electrode for driving liquid crystal is formed through a seal member which is formed on a portion other than a portion serving as a liquid crystal inlet, and then forming panels by cutting out said glued first and second substrates employing laser cutting, wherein at least one substrate of the first and second substrates is a plastic substrate; wherein an opening for passing through either the first or second substrate is formed on a portion serving as a liquid crystal inlet prior to cutting out the glued first and second substrates employing laser cutting; and wherein at least a part of the opening is employed for a portion serving as a liquid crystal inlet at the time of forming the panel by cutting out the first and second substrates, and the panel is cut out in a state wherein the substrate on which the opening is not formed protrudes toward outside of the liquid crystal inlet from the substrate on which the opening is formed.

With a third method for manufacturing a liquid crystal display according to the present invention, the third method for manufacturing a liquid crystal display comprises a step for gluing a first substrate on which an electrode for driving liquid crystal is formed and a second substrate on which an electrode for driving liquid crystal is formed through a seal member which is formed on a portion other than a portion serving as a liquid crystal inlet, and then forming panels by cutting out the glued first and second substrates employing laser cutting, wherein at least one substrate of the first and second substrates is a plastic substrate; wherein a hole serving as a liquid crystal inlet is formed in at least one substrate of the first and second substrates for passing through the substrate prior to gluing the first and second substrates; and wherein the first and second substrates are cut out so as to exclude the hole.

With the first and second liquid crystal displays, an opening for passing through either the first or second substrate is formed on a portion serving as a liquid crystal inlet prior to gluing the first and second substrates, and at least a part of the opening is employed for a portion serving as the liquid crystal inlet of the panel, and accordingly, even in the event of cutting out the first and second substrates employing laser cutting, there is the advantage of preventing fusing between the first and second substrates at the liquid crystal inlet. Consequently, liquid crystal injection can be performed smoothly, problems such that air bubbles are injected into the liquid crystal being injected can be prevented, whereby a liquid crystal display with excellent quality and high yield can be obtained.

With the first and second methods for manufacturing a liquid crystal display according to the present invention, an opening for passing through either the first or second substrate is formed on a portion serving as a liquid crystal inlet prior to cutting out the glued first and second substrates employing laser cutting, at least a part of the opening is employed for a portion serving as the liquid crystal inlet of the panel, and accordingly, even in the event of cutting out the first and second substrates employing laser cutting, fusing between the first and second substrates at the liquid crystal inlet is prevented. Consequently, liquid crystal injection from the liquid crystal inlet can be performed smoothly, and problems such that air bubbles are injected into the liquid crystal being injected can be prevented, thereby enabling a liquid crystal display to be manufactured with excellent quality without reducing yield.

With the third and fourth liquid crystal displays, a hole serving as a liquid crystal inlet passing through at least one substrate of the first and second substrates is formed on the substrate, and accordingly, even in the event that one liquid crystal inlet is disposed on a cutting face which is manufactured by cutting the first and second substrates employing laser cutting, and the liquid crystal inlet is sealed with adhesion by laser cutting, liquid crystal injection can be performed from the liquid crystal inlet made of a hole, thereby preventing one of the conventional problems, which is that liquid crystal injection cannot be performed smoothly due to fusing between the first and second substrates at the liquid crystal inlet. Consequently, liquid crystal injection can be performed smoothly, problems such that air bubbles are injected into the liquid crystal being injected can be prevented, whereby a liquid crystal display with excellent quality and high yield can be obtained.

With the third method for manufacturing a liquid crystal display according to the present invention, a hole serving as a liquid crystal inlet is formed in at least one substrate of the first and second substrates for passing through the substrate prior to gluing the first and second substrates, the first and second substrates are cut out so as to exclude said hole, and accordingly, even in the event that one liquid crystal inlet is disposed on a cutting face which is manufactured by cutting the first and second substrates employing laser cutting, and the liquid crystal inlet is sealed with adhesion by laser cutting, liquid crystal injection can be performed from the liquid crystal inlet made of a hole, thereby preventing one of the conventional problems, which is that liquid crystal injection cannot be performed smoothly due to fusing between the first and second substrates at the liquid crystal inlet. Consequently, liquid crystal injection can be performed smoothly from the liquid crystal inlet, problems such that air bubbles are injected into the liquid crystal being injected can be prevented, thereby providing an advantage in that a liquid crystal display can be manufactured with excellent quality without reducing yield. Moreover, forming the liquid crystal inlet on the extended portion enables the end edge of the panel to completely be immersed in liquid crystal, thereby simultaneously preventing air bubbles from being mixed into liquid crystal from the end edge of the panel.

Thus, the liquid crystal display according to the present invention and the manufacturing method thereof and be suitably and favorably applied to liquid crystal displays using various types of substrates and the manufacturing methods thereof.

### BRIEF DESCRIPTION OF THE DRAWINGS

FIG. 1 is a perspective view illustrating the schematic configuration of a first liquid crystal display according to an embodiment of the present invention;

FIG. 2 is a manufacturing process diagram illustrating a first method for manufacturing a liquid crystal display according to a first embodiment of the present invention;

FIGS. 3A through 3G are manufacturing process diagrams illustrating the first method for manufacturing a liquid crystal display according to the first embodiment of the present invention;

FIG. 4 is a manufacturing process diagram illustrating the first method for manufacturing a liquid crystal display according to the first embodiment of the present invention;

FIG. 5 is a manufacturing process diagram illustrating the first method for manufacturing a liquid crystal display according to the first embodiment of the present invention;

FIG. 6 is a manufacturing process diagram illustrating the first method for manufacturing a liquid crystal display according to the first embodiment of the present invention;

FIG. 7 is a manufacturing process diagram illustrating the first method for manufacturing a liquid crystal display according to the first embodiment of the present invention;

FIG. 8 is a manufacturing process diagram illustrating the first method for manufacturing a liquid crystal display according to a second embodiment of the present invention;

FIGS. 9A and 9B are manufacturing process diagrams illustrating the first method for manufacturing a liquid crystal display according to the second embodiment of the present invention;

FIG. 10 is a manufacturing process diagram illustrating the first method for manufacturing a liquid crystal display according to the second embodiment of the present invention;

FIGS. 11A through 11C are plan views describing shapes of an opening;

FIG. 12 is a perspective view illustrating the schematic configuration of a second liquid crystal display according to an embodiment of the present invention;

FIG. 13 is a plan layout diagram illustrating a second method for manufacturing a liquid crystal display according to an embodiment of the present invention;

FIG. 14 is a plan layout diagram illustrating the second method for manufacturing a liquid crystal display according to an embodiment of the present invention;

FIG. 15 is a perspective view illustrating the schematic configuration of a second method for manufacturing a liquid crystal display according to an embodiment of the present invention;

FIG. 16 is a perspective view illustrating the schematic configuration of a third liquid crystal display according to an embodiment of the present invention;

FIG. 17 is an enlarged view of a panel region illustrating the formation position of a hole according to the third liquid crystal display of the present invention;

FIG. 18 is a plan layout diagram illustrating a third method for manufacturing a liquid crystal display according to an embodiment of the present invention;

FIG. 19 is a plan layout diagram illustrating the third method for manufacturing a liquid crystal display according to an embodiment of the present invention;

FIGS. 20A and 20B are diagrams illustrating the third method for manufacturing a liquid crystal display according to an embodiment of the present invention;

FIGS. 21A through 21J are plan views illustrating specific examples for shapes of an extended portion and opening shapes of a hole; and

FIG. 22 is a plan view illustrating the schematic configuration of a fourth liquid crystal display according to an embodiment of the present invention;

### DESCRIPTION OF THE PREFERRED EMBODIMENTS

Embodiments of the present invention will now be described. Here, the object for preventing adhesion at a liquid crystal inlet when cutting first and second substrates has been realized by a technique wherein the first and second substrates are glued together, and then an opening passing through either the first or second substrate on which a liquid crystal inlet has been formed is formed on a portion serving as a liquid crystal inlet of the substrate, prior to cutting out the glued first and second substrates into panels employing laser cutting.

First Embodiment

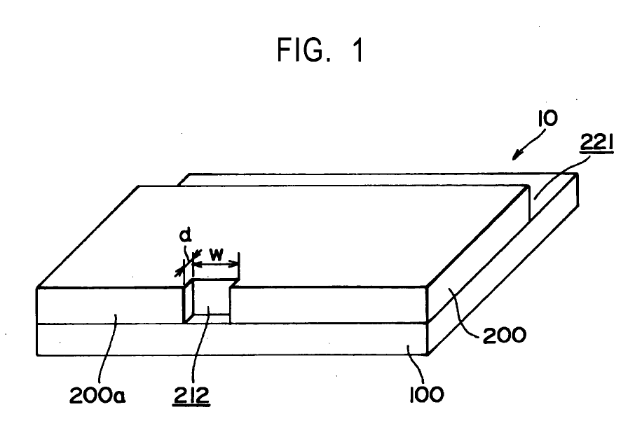

Description will be made regarding a first liquid crystal display according to an embodiment of the present invention with reference to a perspective view of the schematic configuration of the first liquid crystal display in FIG. 1.

As shown in FIG. 1, an active substrate 100 made up of a plastic substrate on which a thin-film device layer for driving liquid crystal, pixel electrodes (not shown), and the like are formed, and a facing substrate 200 made up of a plastic substrate on which facing electrodes (not shown) are formed, are glued with spacers (not shown) and a seal member (not shown) introduced therebetween, and cut out into a liquid crystal display 10 employing laser cutting. A notched portion 212 made up of an opening passing through the facing substrate 200 prior to cutting is formed on a portion serving as a liquid crystal inlet of the facing substrate 200. Furthermore, a pad opening 221 which has been formed on the facing substrate 200 prior to cutting is formed on a pad formation region of the above-described active substrate 100 of the facing substrate 200.

Let us say that the above-described notched portion 212 has the same width w as that of the liquid crystal inlet (not shown), and a depth d of 100 μm from an end face 200a of the facing substrate 200. In the event that the depth d of the notched portion 212 is too small, the plastic substrate of the perimeter portions of the notched portion 212 is melted by the influence of heat due to cutting when being cut into the size of a panel, so the liquid-crystal inlet is sealed with the melted plastic substrate, thereby reducing the advantage of the notched portion 212 being formed. Accordingly, the depth d is preferably 10 μm or more. Conversely, in the event that the depth d is too large, the size of liquid crystal cells becomes large as compared with the display area, so 1 mm or less is preferable. Furthermore, in the event that the depth d exceeds 1 mm, the distance between the active substrate 100 and the facing substrate 200 becomes large at the liquid crystal inlet at the time of liquid crystal injection, and thus it is difficult to perform liquid crystal injection by evacuation. Accordingly, the depth d is preferably set to 10 μm to 1 mm.

Furthermore, a liquid crystal layer (not shown) is formed between the above-described active substrate 100 and facing substrate 200, which is made up of liquid crystal injected from the above-described liquid crystal inlet and sealed in.

With the above-described liquid crystal display 10, the active substrate 100 and the facing substrate 200 are glued together, and then the notched portion 212 made up of an opening passing through the facing substrate 200 is formed on a portion serving as the liquid crystal inlet of either one substrate of the glued active substrate 100 and facing substrate 200, the glued facing substrate 200 in this case, so even in the event of cutting out the active substrate 100 and the facing substrate 200 employing laser cutting, adhesion between the active substrate 100 and the facing substrate 200 can be prevented at the liquid crystal inlet. Consequently, liquid crystal injection is performed smoothly, and also a defective article wherein air bubbles are mixed in the injected liquid crystal can be prevented, thereby obtaining the liquid crystal display 10 with excellent quality.

Note that, with the above-described embodiment, while the notched portion 212 is formed on the facing substrate 200 side, the notched portion 212 may be formed on a portion serving as the liquid crystal inlet of the active substrate 100. That is to say, forming the notched portion 212 on either substrate of the active substrate 100 and the facing substrate 200. Furthermore, with the above-described embodiment, an arrangement may be made wherein a glass substrate is employed for either substrate of the active substrate 100 and the facing substrate 200.

Second Embodiment

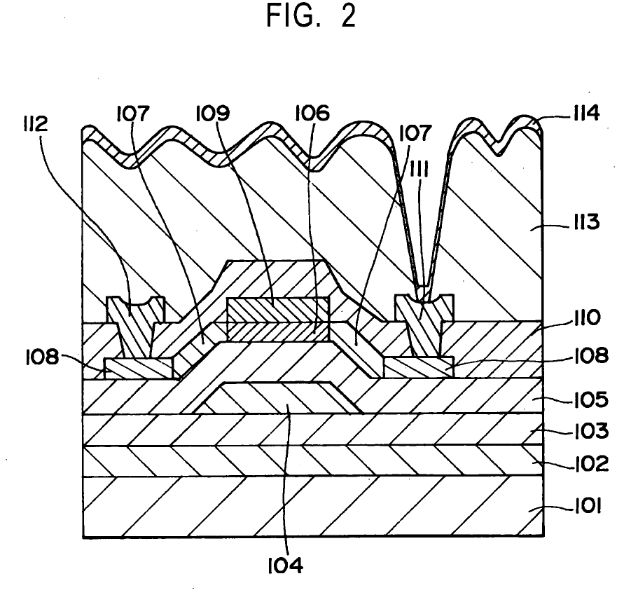

Description will be made regarding a first method for manufacturing a liquid crystal display according to the first embodiment of the present invention with reference to manufacturing process diagrams in FIGS. 2 through 7.

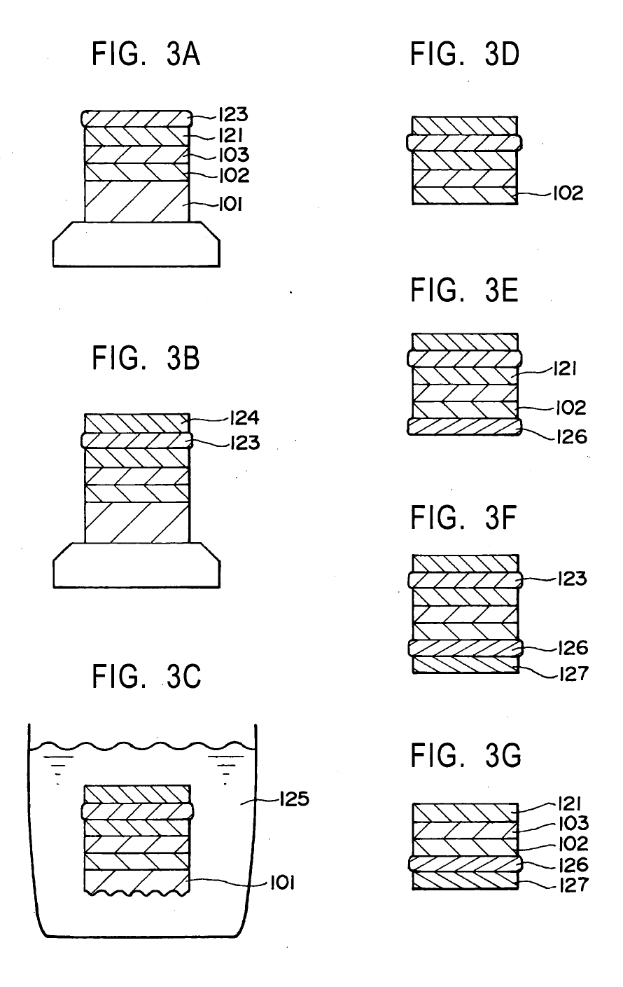

First, in FIGS. 2 and 3, a reflective active substrate is formed on a plastic substrate employing a transfer method, and then a process for manufacturing a liquid crystal display according to the present invention is shown.

As shown in FIG. 2, a glass substrate or quartz substrate with a thickness of 0.4 to 1.1 mm is employed for a first substrate 101 serving as a manufacturing substrate. Subsequently, a molybdenum thin film (Mo) (thickness of 500 nm, for example) is formed on the first substrate 101 (glass substrate with thickness of 0.7 mm, for example) as a protective layer 102 employing sputtering for example, next, a protective insulating layer 103 (SiO₂ layer with thickness of 500 nm, for example) is formed by plasma CVD, following which a TFT is formed as a thin-film device layer employing a low-temperature polysilicon bottom gate thin-film transistor (TFT) process such as a process described in 1999 “Technology equipment materials (Semiconductor FPD world)” (Press Journal issued in 1998 pages 53 to 59), “Flat Panel Display 1999” (Nikkei Business Publications Inc. issued in 1998, pp 132-139) and the like.

First, a gate electrode 104 is formed on the protective insulating layer 103 with a molybdenum film with thickness of 100 nm for example. This gate electrode 104 is formed employing common photolithography and etching. A gate insulating film 105 made up of a silicon oxide (SiO₂) layer or a layered member of a silicon oxide (SiO₂) layer and silicon nitride (SiNₓ) layer is formed so as to cover the gate electrode 104, by plasma CVD. Furthermore, a non-crystalline silicon layer (thickness is 30 to 100 nm) is successively formed. This non-crystalline silicon layer is subjected to pulse irradiation employing an XeCl excimer laser beam with a wavelength of 308 nm so as to manufacture a polysilicon layer as a crystalline silicon layer by melting and recrystallization. A polysilicon layer 106 serving as a channel formation region is formed employing this polysilicon layer, a polysilicon layer 107 made up of an ne⁻-type doped region and polysilicon layer 108 made up of n⁺-type doped region are formed therebetween. As described above, an active region is configured with LDD (Lightly Doped Drain) structure for balancing a high on current and lowoff current. Moreover, a stopper layer 109 for protecting the channel formation region at the time of implanting n⁻-type phosphate ions is formed on the polysilicon layer 106 with silicon oxide (SiO₂) layer for example.

Furthermore, a passivation film 110 made up of a silicon oxide (SiO₂) layer or a layered member of a silicon oxide (SiO₂) layer and silicon nitride (SiNₓ) layer is formed by plasma CVD. A source electrode 111 and drain electrode 112 which are connected to each polysilicon layer are formed on this passivation film 110, with aluminum, for example.

Next, in order to protect elements and perform smoothing, a protective film 113 is formed on the passivation film 110 with an acrylic resin for example so as to cover the source electrode 111 and the drain electrode 112 employing spin coating for example. Concavities and convexities are formed on the surface of the protective film 113 such that the concavities and convexities adhere to pixel electrodes which are formed next, and also a contact hole communicating with the source electrode 111 is formed on the protective film 113. Subsequently, a pixel electrode 114 for connecting to the source electrode 111 through the contact hole is formed on the protective film 113 by forming a film with silver (Ag), for example, by sputtering.

According to the above-described process, a reflective active matrix substrate is manufactured on the glass substrate 101. Next, a process for transferring the thin-film layer on the glass substrate 101 onto the plastic substrate will be described.

As shown in FIG. 3A, the protective layer 102 made up of a molybdenum thin-film, the protective insulating layer 103 made up of a silicon oxide (SiO₂) layer, and a device layer 121 are sequentially formed on the glass substrate 101, which is heated to 80 to 140° C. employing a hot plate 122, while a hot-melt adhesive layer 123 is formed on the above-described device layer 121. A hot-melt adhesive is applied to the device layer 121 to a thickness of 1 mm, for example, so as to form this hot-melt adhesive layer 123.

Next, as shown in FIG. 3B, a molybdenum (Mo) substrate 124 with thickness of 1 mm, for example, is disposed on the hot-melt adhesive layer 123, and cooled down to room temperature, while being pressed. Moreover, an arrangement may be made wherein a hot-melt adhesive is applied to the molybdenum substrate, and then the glass substrate 101 is disposed thereupon.

Next, as shown in FIG. 3C, the glass substrate 101 to which the above-described molybdenum substrate 124 is applied is immersed in an fluorine aqueous solution 125, and then etching of the glass substrate 101 is performed. The fluorine aqueous solution 125 employed here is 50% concentration by weight, and an etching period of 3.5 hours. The density of the fluorine aqueous solution 125 and the etching period may be changed as long as the glass can be completely etched. Consequently, as shown in FIG. 3D, the glass substrate 101 (see FIG. 3C) is completely etched, and the protective layer 102 is exposed.

Next, as shown in FIG. 3E, a second adhesive layer 126 is applied to the above-described protective layer 102 serving as the back face of the above-described thin-film device layer 121 and formed. This second adhesive layer 126 is made up of an ultraviolet curing adhesive agent, and applied to and formed employing spin coating.

Next, as shown in FIG. 3F, a plastic substrate 127 is applied to the above-described second adhesive layer 126 following the second adhesive layer 126 being applied and formed. A polycarbonate film of thickness of 0.2 mm for example is employed for this plastic substrate 127, and application is performed by irradiating ultraviolet rays onto the plastic substrate 127 so as to effect hardening. While polycarbonate is employed for the plastic substrate 127, other plastics besides polycarbonate may be employed. Next, this substrate is immersed in alcohol, the hot-melt adhesive layer 123 is melted so as to separate the molybdenum substrate 124, as shown in FIG. 3G, an active substrate made up of the plastic substrate 127, on which the second adhesive layer 126, the protective layer 102, the protective insulating layer 103, and the thin-film device layer 121 are formed in that order, is obtained.

Subsequently, though not shown in the drawing, an orientation film (a polyimide film, for example) is applied to the above-described active substrate and the facing substrate made up of a plastic substrate on which an indium-tin-oxide (ITO) film is entirely formed as a transparent electroconductive film, following which both the substrates are subjected to rubbing and orientation.

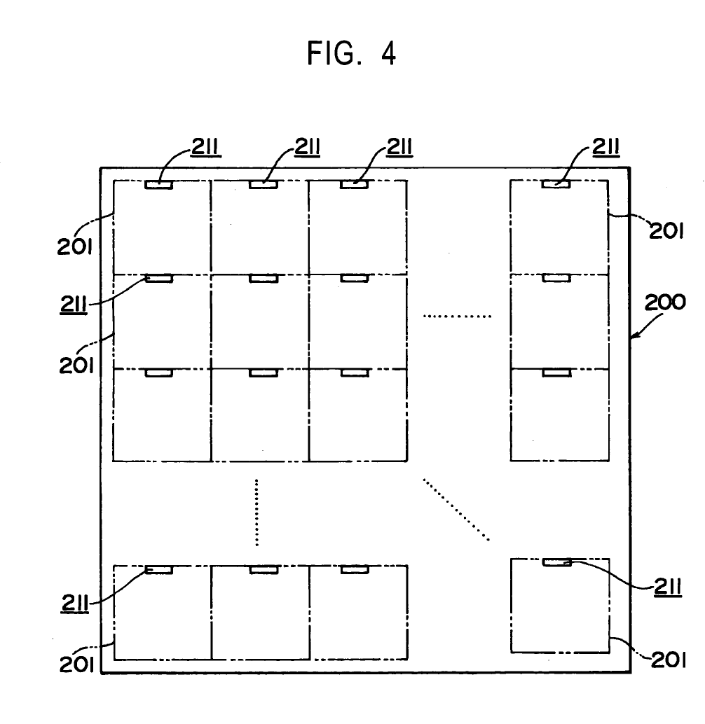

Next, as shown in FIG. 4, openings 211 passing through the facing substrate 200 are formed on a portion serving as a liquid crystal inlet on the facing substrate 200. These openings 211 are formed by laser cutting, for example. While carbon dioxide laser cutting equipment is employed in the present embodiment, any laser cutting equipment may be employed besides this carbon dioxide laser cutting equipment, such as excimer laser cutting equipment, YAG laser cutting equipment, and the like, as long as the laser cutting equipment can emit a laser beam capable of cutting a plastic substrate. The cutting conditions regarding carbon dioxide laser cutting equipment employed here, for example, are that a carbon dioxide laser beam with a wavelength of 10.6 μm is employed, the energy density thereof is set to 2.5 kW/mm², the cutting speed is set to 800 mm/minute. These conditions are selected appropriately depending on the quality of materials and thickness of the plastic substrate, and so forth. The facing substrate 200 shown in FIG. 4 is in a state prior to being cut out into panels, with multiple panel regions 201 are provided on one substrate.

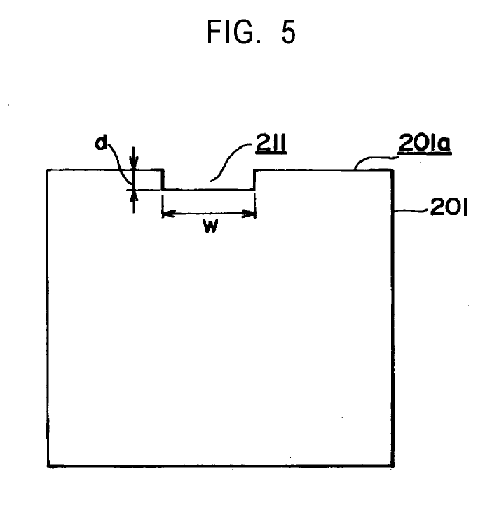

Next, one panel region 201 is described with reference to FIG. 5. As shown in FIG. 5, here, the opening 211 formed on the liquid crystal inlet has the same width w as that of the liquid crystal inlet and a depth d of 100 μm from an end face 201a on which the opening 211 of the panel region 201 is formed. In the event that the depth d of the opening 211 is too small, the plastic substrate at the perimeter portions of the opening 211 is melted by the influence of heat due to laser cutting when cut in the size of a panel, so the liquid crystal inlet is sealed with the melted plastic substrate, thereby reducing the advantage wherein the opening 211 is formed. Accordingly, the depth d is preferably 10 μm or more. Conversely, in the event that the depth d is too large and exceeds 1 mm, the size of liquid crystal cells becomes large as compared with the display area, so 1 mm or less is preferable. Furthermore, in the event that the depth d exceeds 1 mm, the distance between the active substrate and the facing substrate becomes large at the liquid crystal inlet at the time of liquid crystal injection, and thus it is difficult to perform liquid crystal injection by evacuation.

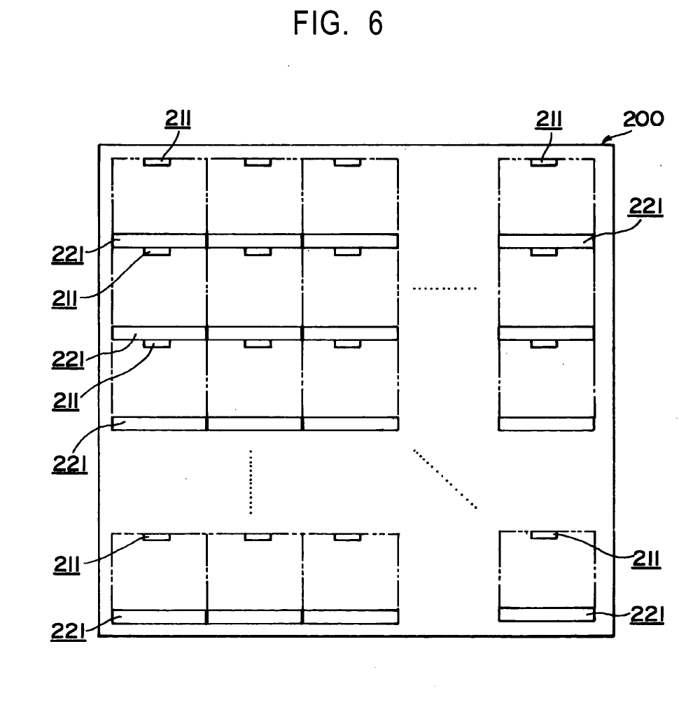

Next, as shown in FIG. 6, pad openings 221 are formed on the facing substrate 200 by removing the portions corresponding to the pad portions of the substrates which are glued together. These pad openings 221 are formed employing laser cutting in the same way as with the above-described openings 211.

Next, though not shown in the drawing, spacers are applied to the facing substrate, a seal member is applied to the active substrate, and then both the substrates are glued together. In order to harden the seal member, the glued substrates are kept at 120° C. for 3 hours while being pressed.

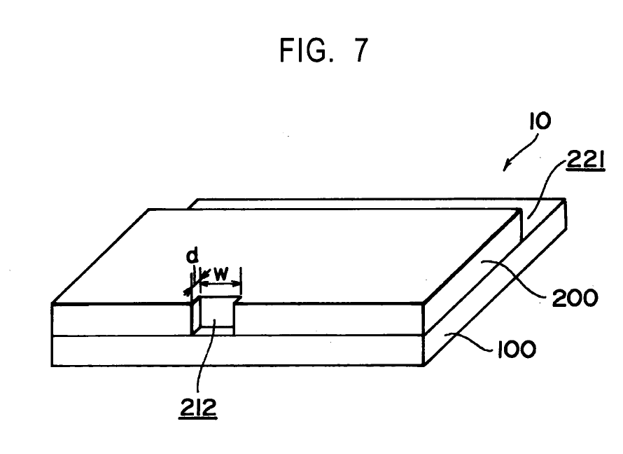

Subsequently, the glued plastic substrates are cut out into the size of liquid crystal panels employing laser cutting. The state following cutting will be described with reference to FIG. 7. As shown in FIG. 7, with the liquid crystal panel 10, the active substrate 100 and the facing substrate 200 are glued together across the seal member, a notched portion 212 (equivalent to the above-described opening 211) is formed on a portion corresponding to the liquid crystal inlet of the facing substrate 200, and also the portion corresponding to the pad portion of the active substrate 100 which is glued with the facing substrate 200 is removed so as to form the pad opening 221. As described above, the notched portion 212 is formed on a portion corresponding to the liquid crystal inlet of the facing substrate 200, and accordingly, even in the event that the glued active substrate 100 and facing substrate 200 are cut out employing laser cutting, the active substrate 100 and the facing substrate 200 are not fused by heat due to laser cutting, consequently, the liquid crystal inlet is not sealed by fusing, where the liquid crystal inlet is secured.

Though not shown in the drawing, the glued substrates are cut out into the size of liquid crystal panels employing the above-described laser cutting, and then liquid crystal is injected from the liquid crystal inlet. Following the liquid crystal injection being completed, the liquid crystal inlet is covered with a molded resin so as to seal the liquid crystal and harden the molded resin, and thus a liquid crystal display is manufactured.

With the above-described method for manufacturing a liquid crystal display, either one of the active substrate 100 and the facing substrate 200 is formed, the facing substrate 200 here for example, the opening 211 passing through the facing substrate 200 is formed on a portion serving as the liquid crystal inlet of the facing substrate 200 prior to cutting employing laser cutting, so even in the event of cutting out the active substrate 100 and the facing substrate 200 employing laser cutting, adhesion between the active substrate 100 and the facing substrate 200 can be prevented at the liquid crystal inlet. Consequently, liquid crystal injection is performed smoothly, and also problems such as air bubbles being mixed in the injected liquid crystal can be prevented, thereby enabling manufacturing of the liquid crystal display 10 with excellent quality.

Third Embodiment

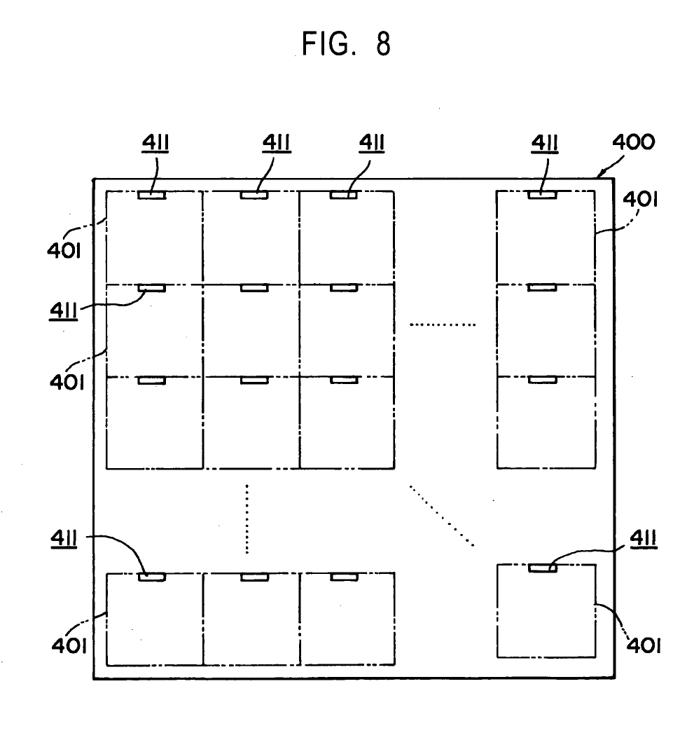

Description will be made regarding a first method for manufacturing a liquid crystal display according to the second embodiment of the present invention with reference to manufacturing process diagrams in FIGS. 8 through 10.

Though not shown in the drawing, a transparent electroconductive film (ITO for example) is formed on the plastic substrate employing sputtering. While the ITO is directly formed on the plastic substrate in this arrangement, a color filter is manufactured on the plastic substrate, and the ITO is formed on the color filter so as to manufacture a color LCD. While the ITO with thickness of 150 nm and resistance of 20 Ω/□ by surface resistance is employed here, any thickness can be set as long as the required resistance can be obtained. Next, the ITO is subjected to patterning employing lithography. Subsequently, an orientation film (polyimide) is applied to the plastic substrate, and then the plastic substrate is subjected to rubbing and orientation.

Next, as shown in FIG. 8, openings 411 passing through one substrate (second substrate 400) of the two plastic substrates (first substrate and second substrate) are formed on a portion serving as a liquid crystal inlet of the second substrate 400. These openings 411 are formed employing laser cutting, for example. While carbon dioxide gas laser cutting equipment is employed here, any laser cutting equipment can be employed besides this gas laser cutting equipment, such as excimer laser cutting equipment, YAG laser cutting equipment, and the like, as long as laser cutting equipment can emit a laser beam capable of cutting a plastic substrate. This conditions are appropriately selected depending on the quality of materials and thickness of the plastic substrate, and so forth. The second substrate 400 shown in FIG. 8 is in a state prior to being cut out into panels wherein multiple panel regions 401 are provided on the one second substrate.

The openings 411 formed on the liquid crystal inlet have the same width w as that of the liquid crystal inlet and a depth d from an end face 401a on which the openings 411 of the panel regions 401 is formed is 100 μm. In the event that the depth d of the openings 411 is too small, the plastic substrate at the perimeter portions of the openings 411 is melted by the influence of heat due to laser cutting when cut in the size of a panel, such that the liquid crystal inlet is sealed with the melted plastic substrate, thereby reducing the advantage wherein the openings 411 are formed. Accordingly, the depth d is preferably 10 μm or more. Conversely, in the event that the depth d is too large, the size of the frame becomes large, so 1 mm or less is preferable. Furthermore, in the event that the depth d exceeds 1 mm, the distance between the first substrate and the second substrate becomes large at the liquid crystal inlet at the time of liquid crystal injection, and thus it is difficult to perform liquid crystal injection by evacuation.

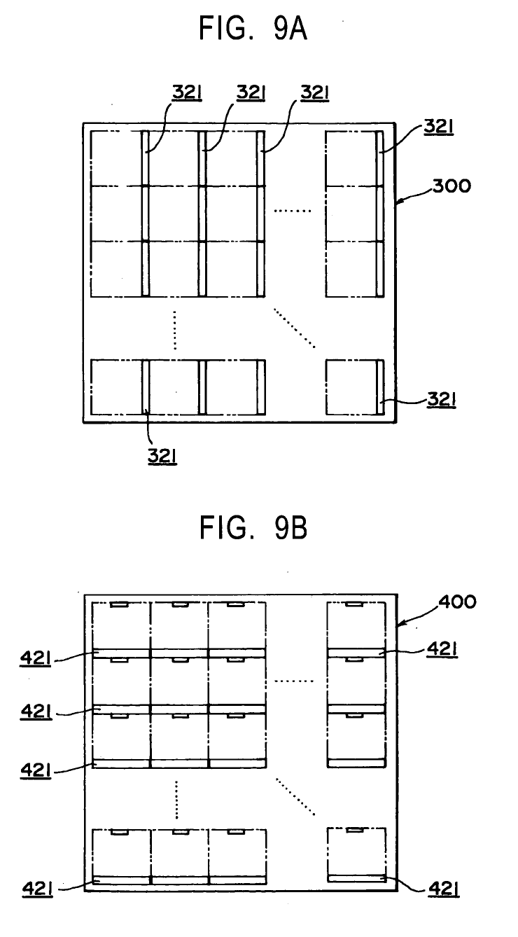

As shown in FIGS. 9A and 9B, the portions corresponding to the pad portions of the second substrate 400 which is glued with the first substrate 300 made up of a plastic substrate, are removed so as to form the pad openings 321, and the portions corresponding to the pad portions of the first substrate 300 which is glued with the second substrate 400 made up of a plastic substrate, are removed so as to form the pad openings 421. These pad openings 321 and 421 are formed employing laser cutting as with the forming of the above-described openings 411. Note that the forming of the openings is not restricted to laser cutting, and other removal techniques can be employed as well.

Next, though not shown in the drawing, spacers are applied to the first substrate, a seal member is applied to the second substrate, and then both the substrates are glued together. In order to harden the seal member, the glued substrates are kept at 120° C. for 3 hours while being pressed. Note that an arrangement may be made wherein the seal member is applied to the first substrate, and the spacers are applied to the second substrate.

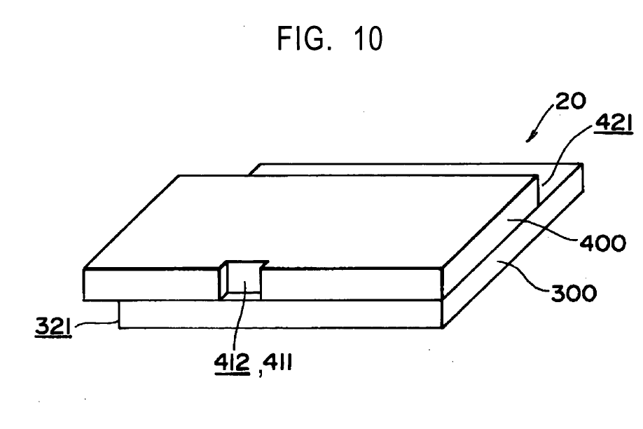

Subsequently, the glued plastic substrates are cut out into the size of liquid crystal panels employing laser cutting. The state following cutting will be described with reference to FIG. 10. As shown in FIG. 10, with a liquid crystal panel 20, the first substrate 300 and the second substrate 400 are glued together through an unshown seal member, and the portion of the second substrate 400 corresponding to the pad portion of the first substrate 300 is removed (corresponding to the above-described pad opening 421). Also, a notched portion 412 (corresponding to the above-described opening 411) is formed on a portion corresponding to the liquid crystal inlet of the second substrate 400, and also the portion of the first substrate 300 corresponding to the pad portion of the second substrate 400 is removed (corresponding to the above-described pad opening 321). As described above, the notched portion 412 is formed on a portion corresponding to the liquid crystal inlet of the second substrate 400, and accordingly, even in the event that the glued first substrate 300 and second substrate 400 are cut out employing laser cutting, the first substrate 300 and the second substrate 400 are not fused due to heat, consequently, the liquid crystal inlet is not sealed by being fused, whereby the liquid crystal inlet is secured.

Though not shown in the drawing, the glued substrates are cut out into the size of liquid crystal panels employing the above-described laser cutting, and then liquid crystal is injected from the liquid crystal inlet. Following the liquid crystal injection being completed, the liquid crystal inlet is covered with a molded resin so as to seal the liquid crystal and harden the molded resin, and thus a liquid crystal display is manufactured.

Even in the event of the above-described first method for manufacturing a liquid crystal display according to the second embodiment, the same advantages can be obtained as with the above-described first method for manufacturing a liquid crystal display according to the first embodiment.

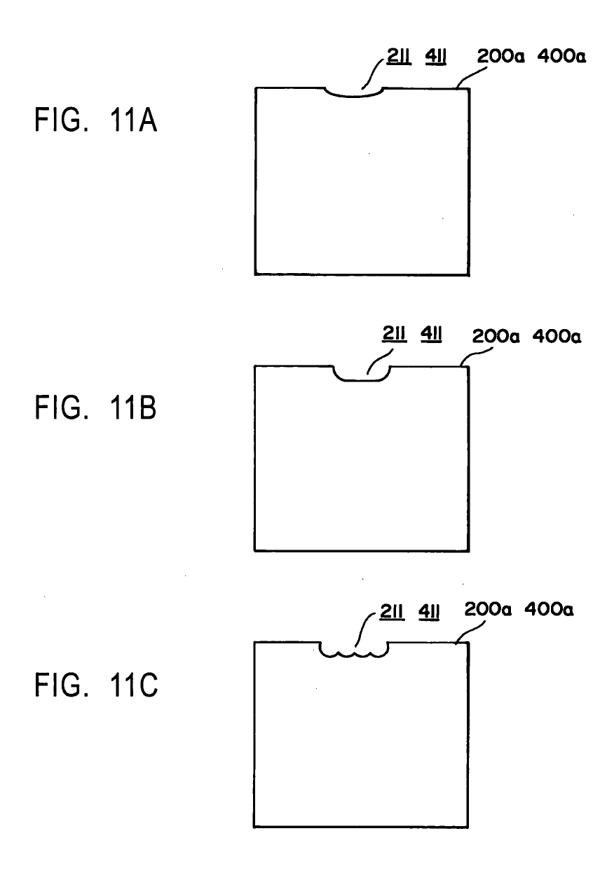

Next, description will be made regarding the shape of the above-described opening. With the above-described first and second embodiments, the opening is formed in a rectangular shape. This shape of the opening 211 (411) may be, for example, in a shape wherein a substrate end face 200a (400a) is removed in a half-ellipse shape as shown in FIG. 11A, in a shape wherein a substrate end face 200a (400a) is removed in a half-oval shape as shown in FIG. 11B, or in a shape wherein a substrate end face 200a (400a) is removed in the shape of multiple circular removal portions overlapping each other as shown in FIG. 11C.

Fourth Embodiment

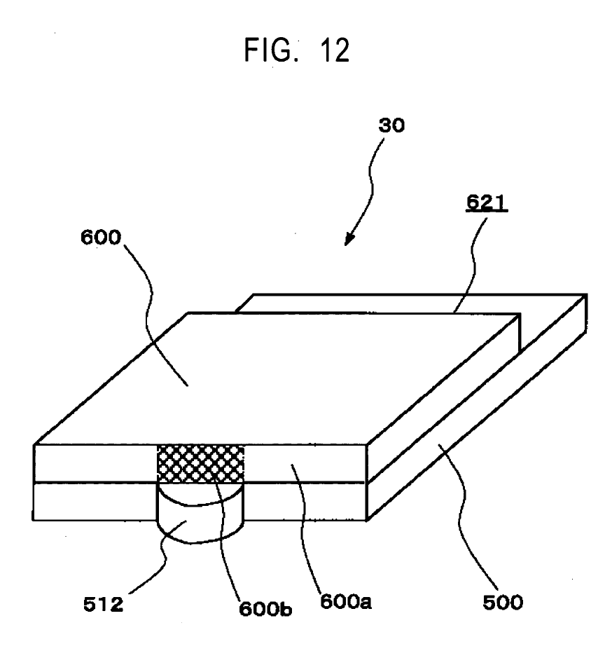

Description will be made regarding a second liquid crystal display according to an embodiment of the present invention with reference to a perspective view of the schematic configuration of the second liquid crystal display in FIG. 12.

As shown in FIG. 12, an active substrate (first substrate) 500 made up of a glass substrate on which a thin-film device layer for driving liquid crystal, pixel electrodes (not shown), and the like are formed, and a facing substrate (second substrate) 600 made up of a plastic substrate on which facing electrodes (not shown) are formed, are glued together with spacers (not shown) and a seal member (not shown) introduced therebetween, which is cut out into a-liquid crystal display 30 employing laser cutting. A part of an opening (side face 600b of opening) passing through the facing substrate 600 prior to cutting is formed on a portion serving as a liquid crystal inlet of the facing substrate 600. That is to say, the side face 600b of the opening is employed for a part of a cutting face 600a of the facing substrate 600 (region indicated by hatching in the drawing). A extended portion 512 is formed in a state wherein the above-described active substrate 500 protrudes outwards from the liquid crystal inlet of the facing substrate 600. Here, for example, the extended portion 512 is formed in a half-circular shape, when viewed from above, on a portion serving as the liquid crystal inlet in a state wherein the extended portion 512 of the active substrate 500 protrudes from the cutting face 600a of the facing substrate 600. The shape of this extended portion 512 is not restricted to in a half-circular shape when viewed from above, and accordingly, any shape such as a rectangle, polygon, or half-ellipse may be employed as long as the extended portion 512 protrudes outwards from the cutting face of the facing substrate 600. Furthermore, a pad opening 621 which is formed on the facing substrate 600 prior to cutting is formed on a pad formation region of the above-described active substrate 500 corresponding to the facing substrate 600.

Furthermore, a liquid crystal layer (not shown) is formed between the above-described active substrate 500 and facing substrate 600, which is made up of liquid crystal injected from the above-described liquid crystal inlet and sealed in.

With the above-described liquid crystal display 30, either substrate of the active substrate 500 and facing substrate 600 may be employed, the facing substrate 600 in this case. The opening passing through the facing substrate 600 is formed on a portion serving as the liquid crystal inlet on the facing substrate 600 prior to gluing the active substrate 500 and the facing substrate 600 together, at least a part of the opening (side face 600b of the opening) is employed for a portion serving as the liquid crystal inlet of a panel, so even in the event of cutting out the active substrate 500 and the facing substrate 600 employing laser cutting, adhesion between the active substrate 500 and the facing substrate 600 can be prevented at the liquid crystal inlet. Consequently, liquid crystal injection is performed smoothly, and also a problems such as air bubbles being mixed in the injected liquid crystal can be prevented, thereby obtaining the liquid crystal display 30 with excellent quality and high yield.

Note that, with the above-described embodiment, while the extended portion 512 is formed on the active substrate 500 side, the extended portion 512 may be formed on the facing substrate 600 side. That is to say, the extended portion 512 can be formed on either substrate of the active substrate 500 and the facing substrate 600. Furthermore, with the above-described embodiment, while a glass substrate is employed for the active substrate 500, a plastic substrate may be employed for the active substrate 500. Furthermore, an arrangement may be made wherein a plastic substrate is employed for the active substrate 500 and a glass substrate is employed for the facing substrate 600.

Fifth Embodiment

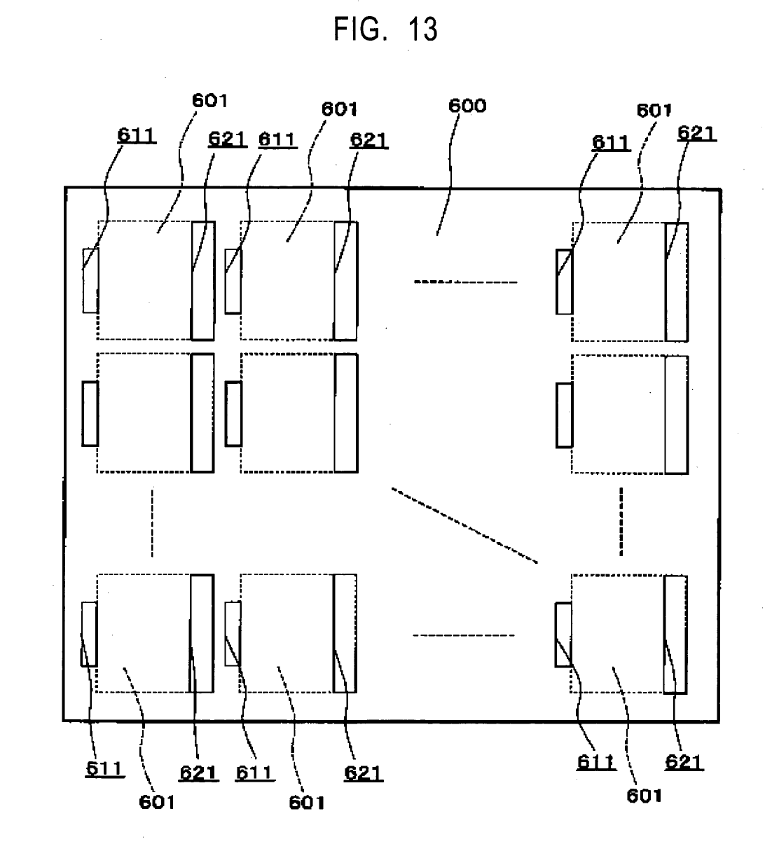

Description will be made regarding a second method for manufacturing a liquid crystal display according to an embodiment of the present invention with reference to FIGS. 13 through 15. In the same method as with the above-described method in FIG. 2, the thin-film device layer 121 is formed on the first substrate 101 made up of a glass substrate. Subsequently, the above-described transfer processes to the plastic substrate (third substrate 127) of the thin-film device layer 121 in FIG. 3 are not performed, and alternately, the first substrate 101 made up of a glass substrate is employed for the supporting substrate of the active substrate. Accordingly, the supporting substrate of the active substrate is made of the glass substrate.

Subsequently, though not shown in the drawing, an orientation film (polyimide layer, for example) is applied to the above-described active substrate and the facing substrate made up of a plastic substrate on which an indium-tin-oxide (ITO) film is entirely formed as a transparent electroconductive film, following which both the substrates are subjected to rubbing and orientation.

Next, as shown in FIG. 13, openings 611 passing through the facing substrate 600 are formed on a portion serving as a liquid crystal inlet on the facing substrate 600. These openings 611 are formed by laser cutting, for example. While carbon dioxide laser cutting equipment is employed here, any laser cutting equipment can be employed besides this carbon dioxide laser cutting equipment, such as excimer laser cutting equipment, YAG laser cutting equipment, and the like as long as the laser cutting equipment can emit a laser beam capable of cutting a plastic substrate. The cutting conditions regarding carbon dioxide laser cutting equipment employed here, for example, are that a carbon dioxide laser beam with a wavelength of 10.6 μm is employed, the energy density thereof is set to 2.5 kW/mm², and the cutting speed is set to 800 mm/minute. These conditions are selected appropriately depending on the quality of materials and thickness of the plastic substrate, and so forth. The facing substrate 600 shown in FIG. 13 is in a state prior to being cut out into panels wherein multiple panel regions 601 (region shown with dashed lines) are provided on one substrate.

Next, pad openings 621 are formed on the facing substrate 600 by removing the portions corresponding to the pad portions of the active substrate 500 which is glued with the facing substrate 600. These pad openings 621 are formed employing laser cutting in the same way as with the above-described openings 611.

Next, though not shown in the drawing, spacers are applied to the facing substrate, a seal member is applied to the active substrate, and then both the substrates are glued together. In order to harden the seal member, the glued substrates are kept at 120° C. for 3 hours while being pressed.

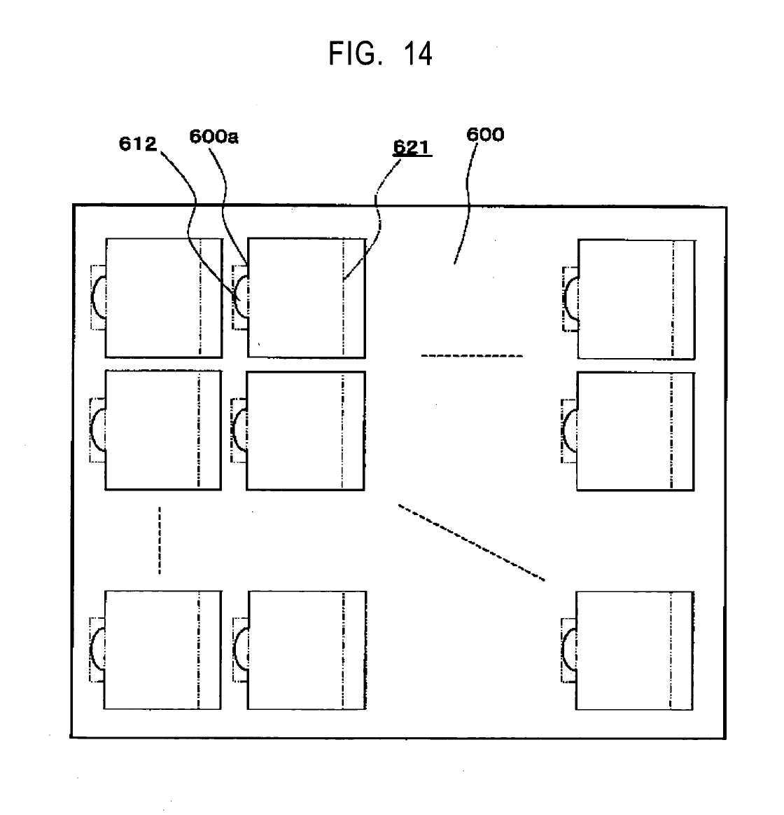

Subsequently, as shown in a plane layout view in FIG. 14, the glued active substrate 500 and facing substrate 600 are cut out in the size of liquid crystal panels employing laser cutting. Cutting is performed as shown with solid lines in the drawing, the extended portions 512 are formed at the liquid crystal inlet 612 in a state wherein the extended portions 512 of the active substrate 500 protrude from the end face 600a of the facing substrate 600. The liquid crystal inlets 612 of the facing substrate 600 are previously cut as the openings 611, so the active substrate 500 and the facing substrate 600 can be cut separately at the liquid crystal inlets 612, thereby preventing a situation wherein the active substrate 500 and the facing substrate 600 are thermally deposited at the cutting face by heat due to working, the liquid crystal inlets 612 are sealed. Note that, in the drawing, while reference numerals are described focusing attention on one panel region as a representative, panel regions with no reference numerals have the same configuration as with the panel region with reference numerals. Note that the openings 611 and 612 which have been formed in the above-described process are shown with dashed lines.

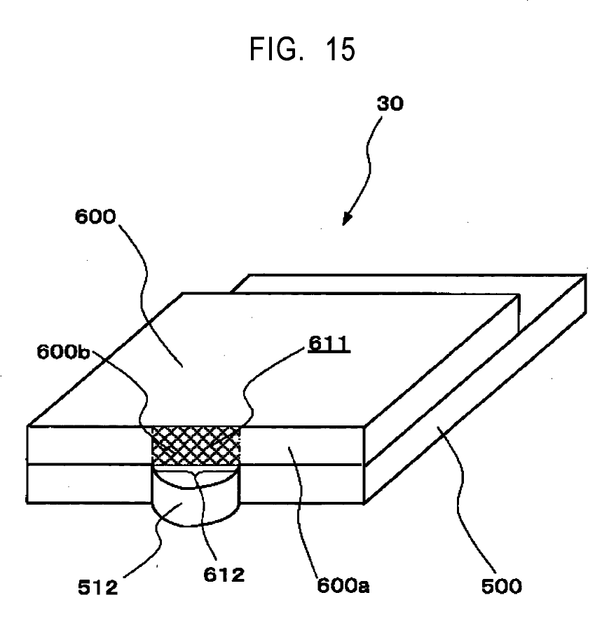

The state following cutting will be described with reference to the perspective view of the schematic configuration in FIG. 15. As shown in FIG. 15, with the liquid crystal panel 30, the active substrate 500 and the facing substrate 600 are glued together with spacers (not shown) and a seal member (not shown) introduced therebetween, a part of the opening 611 (side face 600b of the opening) which has been formed on the facing substrate 600 so as to pass through the facing substrate 600 prior to cutting is formed on a portion serving as the liquid crystal inlet 612 of the facing substrate 600, and the side face 600b of the opening 611 is employed for a part of the cutting face 600a of the facing substrate 600. Furthermore, the above-described active substrate 500 protrudes outwards from the liquid crystal inlet 612-of the above-described facing substrate 600, that is to say, the extended portion 512 of the active substrate 500 is formed in a state wherein the extended portion 512 protrudes from the cutting face 600a of the facing substrate 600 at the portion on which the liquid crystal inlet 612 is formed.

As described above, prior to cutting the active substrate 500 and the facing substrate 600 employing laser cutting, either substrate of the active substrate 500 and the facing substrate 600 can be selected for a substrate on which the opening 611 is formed, in the above-described embodiment the opening 611 is formed on a portion serving as the liquid crystal inlet 612 of the panel of the facing substrate 600, the extended portion 512 is formed on a portion of the active substrate 500 corresponding to the liquid crystal inlet 612 in a state wherein the extended portion 512 protrudes from the end face 600a of the facing substrate 600, and thus, even in the event of simultaneously cutting out the active substrate 500 and the facing substrate 600, adhesion between the active substrate 500 and the facing substrate 600 can be prevented at the liquid crystal inlet 612. Consequently, liquid crystal injection is smoothly performed from the liquid crystal inlet 612, and also problems such as air bubbles becoming mixed in the injected liquid crystal can be prevented, thereby obtaining an advantage wherein the liquid crystal display 30 with excellent quality can be manufactured without reducing yield.

Though not shown in the drawing, the glued substrates are cut out into the size of liquid crystal panels employing the above-described laser cutting, and then liquid crystal is injected from the liquid crystal inlet. Following the liquid crystal injection being completed, the liquid crystal inlet is covered with a molded resin so as to seal the liquid crystal and harden the molded resin, thus a liquid crystal display is manufactured.

With the above-described second method for manufacturing a liquid crystal display, the liquid crystal inlet 612 is disposed on at least the same face as the end face 600a of the facing substrate 600, and thus, hardly any air comes into liquid crystal at the time of liquid crystal injection, and also liquid crystal injection failure hardly ever occurs, as compared with the above-described first method for manufacturing a liquid crystal display. Alternately, with the above-described embodiment, while a glass substrate serving as the supporting substrate of the active substrate 500 is employed without reducing the thickness thereof, a thinned glass substrate, or a thinned glass substrate which is protected with a plastic film and so forth may be employed as well.

With the first method for manufacturing a liquid crystal display, the glass substrate formed on the thin-film device layer may be employed for the supporting substrate of the active substrate as with the above-described second method for manufacturing a liquid crystal display. Furthermore, with the above-described second method for manufacturing a liquid crystal display, a plastic substrate may be employed for the supporting substrate of the active substrate instead of a glass substrate as with the above-described first method for manufacturing a liquid crystal display.

Sixth Embodiment

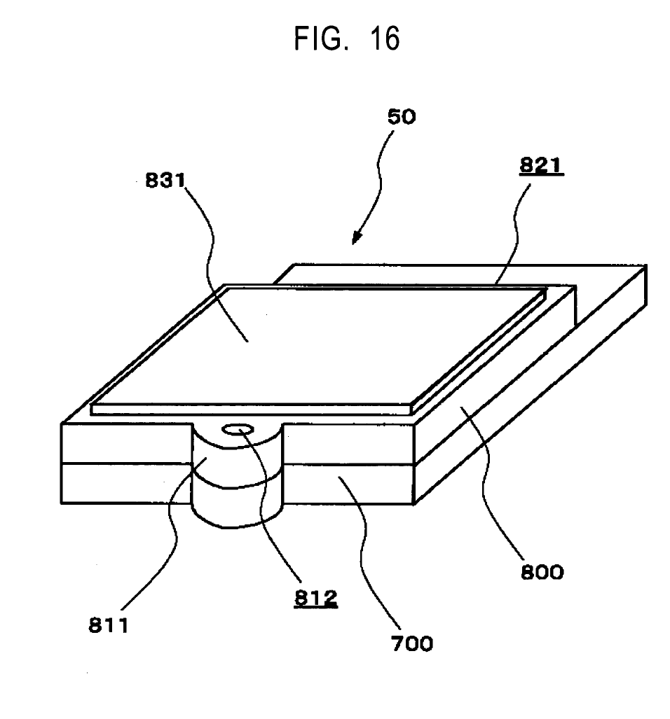

Description will be made regarding a third liquid crystal display according to an embodiment of the present invention with reference to a perspective view of the schematic configuration of the third liquid crystal display in FIG. 16.

As shown in FIG. 16, an active substrate (first substrate) 700 made up of a plastic substrate on which a thin-film device layer for driving liquid crystal, pixel electrodes (not shown), and the like are formed, and a facing substrate (second substrate) 800 made up of a plastic substrate on which facing electrodes (not shown) are formed, are glued together with spacers (not shown) and a seal member (not shown) introduced therebetween, and is cut out into a liquid crystal display 50 employing laser cutting. An extended portion 811 is formed on a portion serving as a first liquid crystal inlet disposed between the active substrate 700 and the facing substrate 800, which protrudes from the active substrate 700 and the facing substrate 800, a hole 812 serving as a second liquid crystal inlet is formed on the extended portion 811 side on the facing substrate 800, which passes through the substrate. Description will be made later regarding the formation position of this hole 812. This extended portion 811 is formed in a half-circular shape when viewed from above. However, the shape of the extended portion 811 is not restricted to this shape. The extended portion 811 in any shape such as a rectangle, polygon, half-ellipse, half-oval can obtain the same effect as with one in a half-circular shape. Moreover, a pad opening 821 formed on the facing substrate 800 prior to cutting is formed on the pad formation region of the active substrate 700. Furthermore, a polarizing plate 831 is formed on the above-described facing substrate 800.

Furthermore, a liquid crystal layer (not shown) is formed between the above-described active substrate 700 and facing substrate 800, which is made up of liquid crystal injected from the above-described liquid crystal inlet and enclosed.

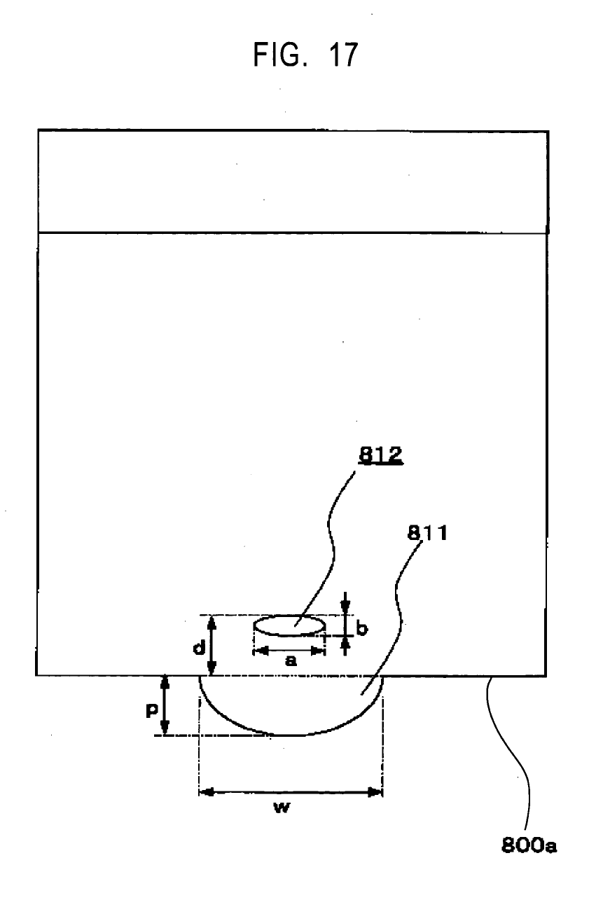

Next, an example of the formation position of the hole 812 serving as the above-described second liquid crystal inlet will be described with reference to the enlarged view of the panel region in FIG. 17. As shown in FIG. 17, the above-described extended portion 811 is formed such that the width w of the extended portion 811 generally matches the width of the first liquid crystal inlet made up of a region on which the seal member (not shown) formed between the active substrate 700 and the facing substrate 800 is not formed. Moreover, the extended amount p of the extended portion 811 corresponding to a panel end edge 800a can be appropriately set, and is set to 0.2 to 1.0 mm for example, here. The above-described hole 812 is formed within the region of d=1 mm or less in the inner direction of the facing substrate 800 from a line extending from the end edge 800a of a portion on which the extended portion 811 is not formed to the extended portion 811 side, and within the region of the extended portion 811. For example, the oval hole 812 with major axis a=0.5 mm and minor axis b=0.1 mm is formed on a position of d=0.2 mm or less.

Next, the reason for d=1 mm or less will be described. For example, in the event that the hole 812 is formed on a region exceeding d=1 mm, the hole 812 is disposed above the liquid crystal interface at the time of liquid crystal injection, and accordingly, air comes into the panel (between the active substrate 700 and the facing substrate 800), thereby leading to a problem of air bubbles within the injected liquid crystal. Accordingly, as-described above, the formation position of the hole 812 is preferably d=1 mm or less.

With the above-described liquid crystal display 50, the hole 812 serving as a liquid crystal inlet passing through the facing substrate 800 is formed on the facing substrate 800, for example, of the active substrate 700 and the facing substrate 800, and accordingly, even in the event that the first liquid crystal inlet is disposed on a cutting face which is manufactured by cutting the active substrate 700 and the facing substrate 800 employing laser cutting, and the first liquid crystal inlet is sealed with adhesion by laser cutting, liquid crystal injection can be performed from the second liquid crystal inlet made of the hole 812, thereby preventing one of the conventional problems, which is the problem that liquid crystal injection cannot be smoothly performed due to fusing between the substrates at the liquid crystal inlet. Consequently, liquid crystal injection can be smoothly performed, and problems of air bubbles coming into the injected liquid crystal can be prevented, thereby providing an advantage that the liquid crystal display 50 can be obtained with excellent quality and high yield. Moreover, forming the extended portion 811 enables the liquid crystal inlet to be immersed in liquid crystal at the time of liquid crystal injection, thereby providing another advantage wherein liquid crystal injection is smoothly performed.

With the above-described embodiment, while an example wherein the hole 812 serving as the second liquid crystal inlet is formed on the facing substrate 800 has been described, even in the event that the same hole as the hole 812 is formed on the active substrate 700, the same advantages as with the above-described embodiment can be obtained. In other words, the hole 812 can be formed on a position of the above-described active substrate 700 facing the position of the above-described facing substrate 800 on which the hole 812 is formed. Furthermore, an arrangement may be made wherein the two holes 812 are formed on positions of both the active substrate 700 and the facing substrate 800, satisfying the above-described conditions.

Seventh Embodiment

Description will be made regarding a third method for manufacturing a liquid crystal display according to an embodiment of the present invention with reference to FIGS. 17 through 20B.

First, an active substrate is formed with the same method for manufacturing a liquid crystal display as with the above-described second embodiment. Subsequently, though not shown in the drawing, an orientation film (polyimide film, for example) is applied to the above-described active substrate and the facing substrate made up of a plastic substrate on which an indium-tin-oxide (ITO) film is entirely formed as a transparent electroconductive film, following which both the substrates are subjected to rubbing and orientation.

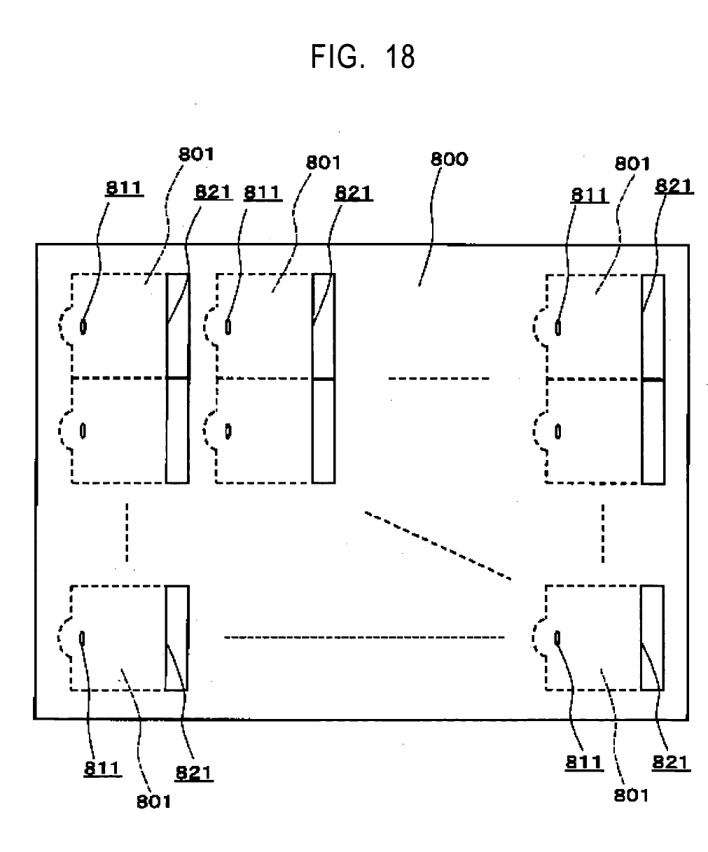

Next, description will be made regarding a precutting process of the facing substrate with reference to a plan view of the schematic configuration in FIG. 18 and an enlarged view of panel regions in FIG. 17. Note that dashed lines in the drawings indicate cutting lines for cutting the active substrate and the facing substrate out into panels, which is performed in later processes.

First, as shown in FIG. 18, employing laser cutting for example, the holes 812 are formed on a portion serving as a liquid crystal inlet of the facing substrate 800 so as to pass through the facing substrate 800, and the pad openings 821 for opening a terminal formation region are formed. This laser cutting involves irradiating a laser beam along each cutting shape. Note that the facing substrate 800 shown in FIG. 18 is in a state wherein multiple panel regions 801 are provided on one substrate prior to cutting into panels.

As described with reference to FIG. 17, with the end edge of the facing substrate 800 on which the extended portions 811 are formed in a later process, the hole 812 is formed within the region of d=1 mm or less in the inner direction of the facing substrate 800 from a line extending from the end edge 800a of a portion on which the extended portion 811 is not formed to the extended portion 811 side, and within the region of the extended portion 811. For example, the oval hole 812 with major axis a=0.5 mm and minor axis b=0.1 mm is formed on a position of d=0.2 mm or less.

Next, the reason for d=1 mm or less will be described. For example, in the event that the hole 812 is formed on a region exceeding d=1 mm, the hole 812 is disposed above the liquid crystal interface at the time of liquid crystal injection, and accordingly, air comes into the panel (between the active substrate 700 and the facing substrate 800), thereby leading to a problem of air bubbles within the injected liquid crystal. Accordingly, as described above, the formation position of the hole 812 is preferably d=1 mm or less.

While carbon dioxide laser cutting equipment is employed here, any laser cutting equipment can be employed besides this carbon dioxide laser cutting equipment, such as excimer laser cutting equipment, YAG laser cutting equipment, and the like as long as the laser cutting equipment can emit a laser beam capable of cutting a plastic substrate. The cutting conditions regarding carbon dioxide laser cutting equipment employed here, for example, are that a carbon dioxide laser beam of a wavelength of 10.6 μm is employed, the energy density thereof is set to 2.5 kW/mm², the cutting speed is set to 800 mm/minute. These conditions-are selected appropriately depending on the quality of materials and thickness of the plastic substrate, and so forth.

Next, though not shown in the drawing, spacers are applied to the facing substrate, a seal member is applied to the active substrate except the first liquid crystal inlet, and then both the substrates are glued together. In order to harden the seal member, the glued substrates are kept at 120° C. for 3 hours while being pressed.

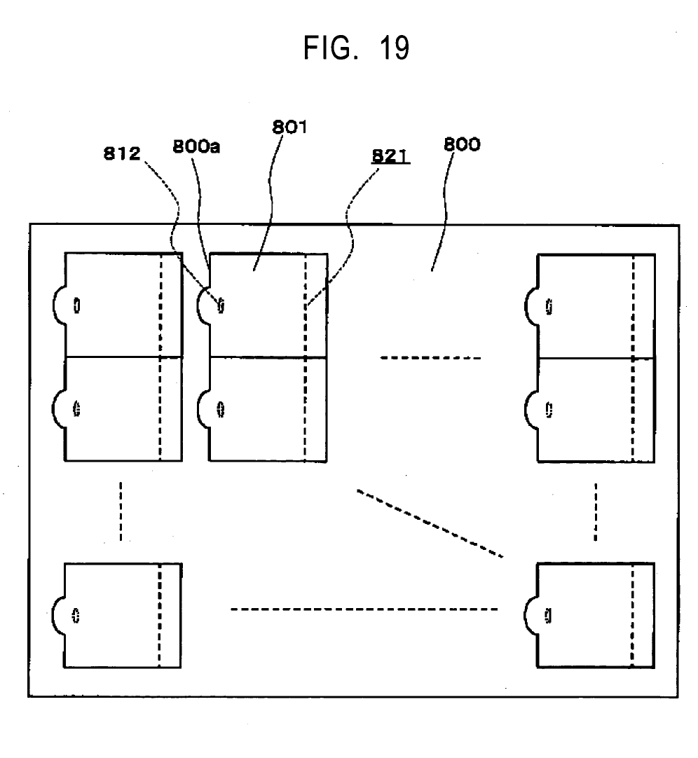

Subsequently, as shown in FIG. 19, the glued active substrate 700 and facing substrate 800 are cut out in the size of liquid crystal panels following a panel region 801 employing laser cutting. Cutting is performed as shown with solid lines in the drawing, the extended portion 811 is formed on the active substrate 700 and the facing substrate 800 in a state wherein the extended portion 811 protrudes from the end face 800a of the facing substrate 800. Note that, in the drawing, while reference numerals have been given focusing attention on one representative panel region, panel regions with no reference numerals have the same configuration as with the panel region with reference numerals. Note that the holes 812 and pad openings 821 which have been formed in the above-described process are shown with dashed lines.

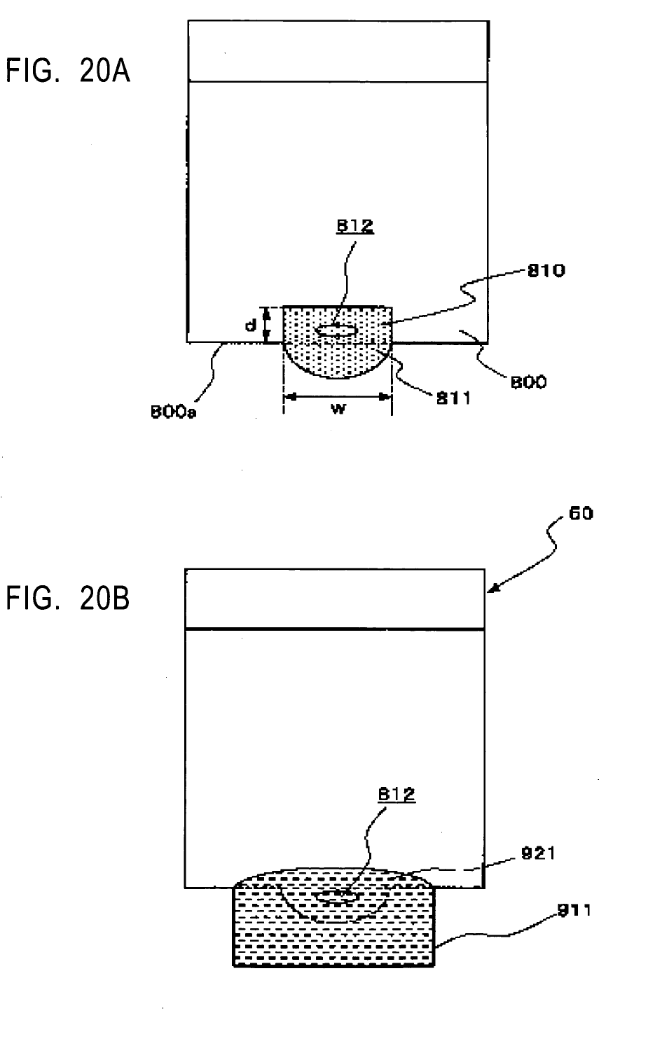

The state following cutting will be described with reference to FIGS. 20A and 20B. FIG. 20A is a plan view illustrating the entire panel after cutting. FIG. 20B is a schematic diagram illustrating an injection process. As shown in FIG. 20A, with the, end edge of the facing substrate 800 on which the extended portion 811 is formed in a later process, the above-described hole 812 is formed within the region of d=1 mm or less in the inner direction of the facing substrate 800 from a line (shown with two-dot broken lines in the drawing) extending from the end edge 800a of a portion on which the extended portion 811 is not formed to the extended portion 811 side, and within a injection region 810 (region shown with dotted patterns) made up of the region of the extended portion 811. The width of the extended portion 811 is the width w of the above-described injection region 810. Furthermore, the extended amount of the extended portion 811 can be set accordingly.

Following the glued substrates in the size of a panel being cut employing laser cutting, as shown in FIG. 20A, liquid crystal is injected from the hole 812 serving as a first liquid crystal inlet (not shown) and a second liquid crystal inlet. This liquid crystal injection is performed in a situation wherein the above-described injection region 810 is immersed in the liquid crystal of a liquid crystal port 911 while providing negative pressure in the space between the substrates of the panel. At this time, liquid crystal 921 in the liquid crystal port 911 bulges upwards toward the panel side and the hole 812 is covered.

Following the liquid crystal injection being completed, though not shown in the drawing, the liquid crystal inlets are sealed with a molded resin so as to seal the liquid crystal, whereby the molded resin is hardened. Bonding a polarizing plate onto the facing substrate of the liquid crystal cell thus formed manufactures the liquid crystal display 50 described with reference to FIG. 16.

With the liquid crystal display 50 manufactured employing the above-described third manufacturing method, prior to cutting panels employing laser cutting, at least one substrate of the active substrate 700 and the facing substrate 800 is employed for a substrate on which the second liquid crystal inlet is formed, in the above-described embodiment, the hole 812 is formed on the facing substrate 800 as the second liquid crystal inlet so as to pass through the facing substrate 800, following the active substrate 700 and the facing substrate 800 being glued together, and the glued substrates are cut out in the panel shape employing laser cutting so as to prevent the hole 812 from being cut by forming the extended portion 811. Thus, even in the event that the active substrate 700 and the facing substrate 800 are melted by heat due to laser cutting at the cutting surfaces of the substrates, and the first liquid crystal inlet which has been provided on the end sides of the active substrate 700 and the facing substrate 800 is sealed, liquid crystal can be injected from the hole 812 serving as the second liquid crystal inlet. Consequently, the liquid crystal injection can be smoothly performed at least from the hole 812 serving as the second liquid crystal inlet. Furthermore, the first and second liquid crystal inlets are formed on the extended portion 811, whereby the end edge of the panel is completely immersed in the liquid crystal, in other words, the first and second liquid crystal inlets can be immersed in the liquid crystal, thereby preventing problems such as air bubbles coming into the injected liquid crystal. Accordingly, an advantage can be provided in that a liquid crystal display is manufactured with excellent quality without reducing yield.

With the above-described embodiment of the third manufacturing method, while an example wherein the hole 812 serving as the second liquid crystal inlet is formed on the facing substrate 800 has been described, but even in the event that the same hole as the hole 812 is formed on the active substrate 700, the same advantage as with the above-described embodiment can be obtained. In other words, the hole 812 can be formed on a position of the above-described active substrate 700 facing the position of the above-described facing substrate 800 on which the hole 812 is formed. Furthermore, an arrangement may be made wherein the two holes 812 are formed on positions of both the active substrate 700 and the facing substrate 800, satisfying with the above-described conditions.

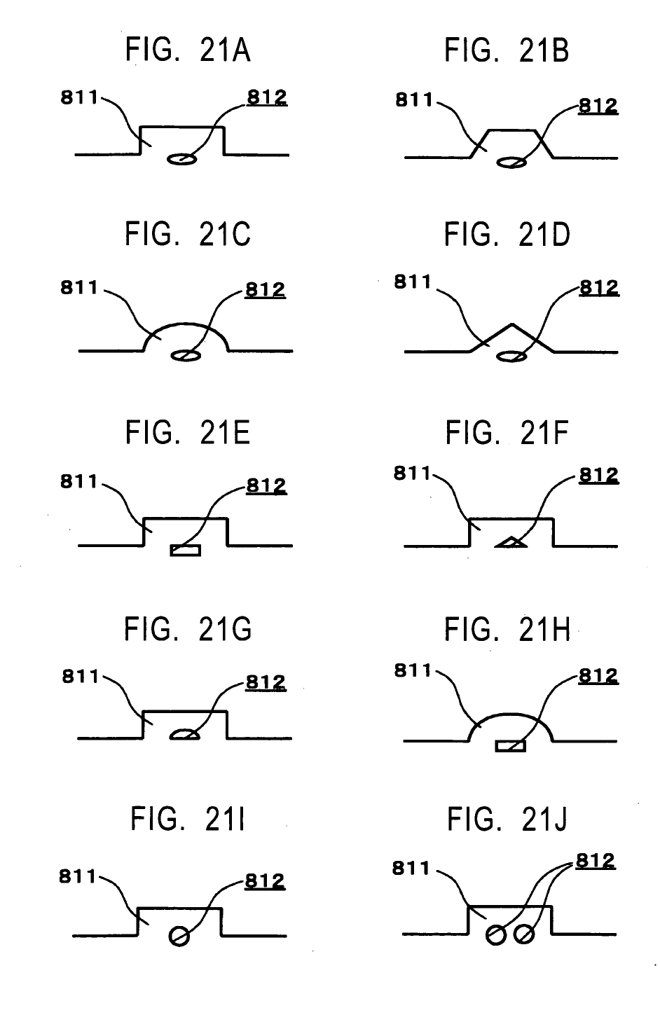

Next, the specific examples regarding the shape of the extended portion 811 and the opening shape of the hole 812 will be described with reference to FIGS. 21A through 21J. As shown in FIGS. 21A through 21J, with regard to the shape of the above-described extended portion 811, rectangles, trapezoids, half-ovals (including half-ellipses), and triangles can be employed. In addition, squares, polygons, for example, and so forth, can be employed. AS for the opening shape of the hole 812, circles, ovals (including ellipses), quadrangles, triangles, polygons, half-circles, half-ovals (including half-ellipses), and so forth can be employed. Furthermore, as shown in FIG. 21J, multiple holes 812 may be formed. While two holes 812 are formed in the drawing, 3 or more holes 812 may be formed as long as they are formed within the above-described region. Of course, even in the event that the above-described shapes of the extended portion 811 and the above-described opening shapes of the hole 812 are employed, the same advantages as with the above-described embodiment can be obtained.

Eighth Embodiment

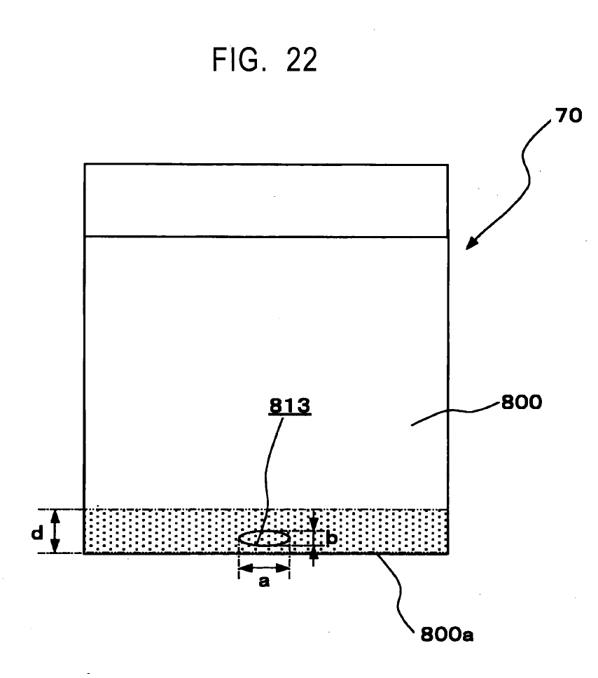

Description will be made regarding a fourth liquid crystal display according to an embodiment of the present invention with reference to a perspective view of the schematic configuration of the second liquid crystal display in FIG. 22.

As shown in FIG. 22, an active substrate (first substrate) (not shown) made up of a plastic substrate on which a thin-film device layer for driving liquid crystal, pixel electrodes (not shown), and the like are formed, and a facing substrate (second substrate) 800 made up of a plastic substrate on which facing electrodes (not shown) are formed, are glued with spacers (not shown) and a seal member (not shown) introduced therebetween, and is cut out into a liquid crystal display 70 employing laser cutting. The liquid crystal inlet (first liquid crystal inlet) may be formed between the active substrate 700 and the facing substrate 800 in the conventional way. The hole 813 serving as a second liquid crystal inlet is formed so as to pass through the facing substrate 800 on the side of the facing substrate 800 on which the first liquid crystal inlet is formed. The position on which this hole 813 is formed is within a region of d=1 mm or less in the inner direction of the facing substrate 800 from the end edge 800a of the facing substrate 800 (dotted region shown in the drawing). For example, the hole 813 with major axis a=0.5 mm and minor axis b=0.1 mm is formed in an oval shape. With regard to this hole 813, the same shapes and numbers as with the above-described hole 812 in FIG. 21 can be employed.

Next, the reason for d=1 mm or less will be described For example, in the event that the hole 813 is formed on a region exceeding d=1 mm, the hole 813 is disposed above liquid crystal interface at the time of liquid crystal injection, and accordingly, air comes into the panel (between the active substrate 700 and the facing substrate 800), thereby leading to a problem of air bubbles within the injected liquid crystal. Accordingly, as described above, the formation position of the hole 813 is preferably d=1 mm or less.

Furthermore, a liquid crystal layer (not shown) is formed between the above-described active substrate 700 and facing substrate 800, which is made up of liquid crystal injected from the above-described liquid crystal inlet and enclosed.

With the above-described liquid crystal display 70, the same advantages as with the above-described liquid crystal display 50 can be obtained by forming the hole 813. With this method, when the glued active substrate 700 and facing substrate 800 are cut out in a panel shape in the above-described third manufacturing method, cutting out into panels should be done without forming the extended portion 811. Other processes besides cutting out into panels are the same as with the above-described third manufacturing method.

With the above-described embodiment, while an example wherein the hole 813 serving as the second liquid crystal inlet is formed on the facing substrate 800 has been described, the same advantages as with the above-described embodiment can be obtained even in the event that the same hole as the hole 813 is formed on the active substrate 700. In other words, the hole 813 can be formed on a position of the above-described active substrate 700 facing the position of the above-described facing substrate 800 on which the hole 813 is formed. Furthermore, an arrangement may be made wherein the two holes 813 are formed on positions of both the active substrate 700 and the facing substrate 800, satisfying the above-described conditions.

Moreover, the configurations of the liquid crystal displays according to the above-described embodiments can be applied to reflective liquid crystal displays, transmissive liquid crystal display having no reflecting plate, and semi-transmissive liquid crystal displays as well, thereby obtaining the same advantages.

Furthermore, while with each liquid crystal display according to the above-described embodiments, the case wherein a transparent electrode is directly formed on a facing substrate has been described, an arrangement may be made wherein a color filter is formed on a plastic substrate on which a transparent electrode is formed, so as to obtain, as a color liquid crystal display, the same effects as with the above-described case.

What is claimed is:

1. A liquid crystal display comprising:
a first substrate on which a first electrode for driving liquid crystal is formed;
a second substrate on which a second electrode for driving liquid crystal is formed; and
a liquid crystal layer held between said first substrate and said second substrate;
wherein at least one substrate of said first substrate and said second substrate is a plastic substrate;
and wherein said first substrate and said second substrate are glued together, and then the glued first and second substrates are cut out into panels employing laser cutting;
and wherein an opening for passing through either said first substrate or said second substrate is formed on a portion serving as a liquid crystal inlet prior to gluing said first substrate and said second substrate;
and wherein a notched portion in which at least a part of said opening is employed is formed on a portion serving as said liquid crystal inlet of said panel.

2. A liquid crystal display according to claim 1, wherein said notched portion is formed with a depth of 10 μm to 1 mm from the substrate end edge on which said notched portion is formed toward the inner side of the substrate.

3. A method for manufacturing a liquid crystal display comprising a step for gluing a first substrate on which an electrode for driving liquid crystal is formed and a second substrate on which an electrode for driving liquid crystal is formed through a seal member which is formed on a portion other than a portion serving as a liquid crystal inlet, and then forming liquid crystal cells by cutting out said glued first and second substrates employing laser cutting;
wherein at least one substrate of said first substrate and said second substrate is a plastic substrate;
and wherein an opening for passing through either said first substrate or said second substrate is formed on a portion serving as a liquid crystal inlet prior to cutting out said glued first substrate and said second substrate employing laser cutting;
and wherein a notched portion in which at least a part of said opening is employed is formed on a portion serving as said liquid crystal inlet of said liquid crystal cell which is formed by cutting out said glued first and second substrates.

4. A method for manufacturing a liquid crystal display according to claim 3, wherein said notched portion is formed with a depth of 10 μm to 1 mm from a substrate end edge on which said notched portion is formed toward the inner side of the substrate.

5. A liquid crystal display comprising:
a first substrate on which a first electrode for driving liquid crystal is formed;
a second substrate on which a second electrode for driving liquid crystal is formed; and
a liquid crystal layer held between said first substrate and said second substrate;
wherein at least one substrate of said first substrate and said second substrate is a plastic substrate;
and wherein said first substrate and said second substrate are glued together, and then the glued first and second substrates are cut out into panels employing laser cutting;
and wherein an opening for passing through either said first substrate or said second substrate is formed on a portion serving as a liquid crystal inlet prior to gluing said first substrate and said second substrate;
and wherein at least a part of said opening is employed for a portion serving as a liquid crystal inlet of said panel;
and wherein said panel is cut out in a state wherein the substrate on which said opening is not formed protrudes toward outside of said liquid crystal inlet from the substrate on which said opening is formed.

6. A method for manufacturing a liquid crystal display comprising a step for gluing a first substrate on which an electrode for driving liquid crystal is formed and a second substrate on which an electrode for driving liquid crystal is formed through a seal member which is formed on a portion other than a portion serving as a liquid crystal inlet, and then forming panels by cutting out said glued first and second substrates employing laser cutting,
wherein at least one substrate of said first substrate and said second substrate is a plastic substrate;
and wherein an opening for passing through either said first substrate or said second substrate is formed on a portion serving as a liquid crystal inlet prior to cutting out said glued first substrate and said second substrate employing laser cutting;
and wherein at least a part of said opening is employed for a portion serving as a liquid crystal inlet at the time of forming said panel by cutting out said first substrate and said second substrate, and said panel is cut out in a state wherein the substrate on which said opening is not formed protrudes toward outside of said liquid crystal inlet from the substrate on which said opening is formed.

7. A liquid crystal display comprising:
a first substrate on which a first electrode for driving liquid crystal is formed;
a second substrate on which a second electrode for driving liquid crystal is formed; and
a liquid crystal layer held between said first substrate and said second substrate;
wherein at least one substrate of said first substrate and said second substrate is a plastic substrate;
and wherein an extended portion protruding toward outside of said first substrate and said second substrate is formed;
and wherein a hole serving as a liquid crystal inlet is formed on at least one substrate region of said first substrate and said second substrate on the side of said extended portion, for passing through the substrate.

8. A liquid crystal display according to claim 7, wherein, in the substrate end edge on which said extended portion is formed, said hole is formed within a region of 1 mm or less in the inner side direction of the substrate from a line extending from the end edge of the portion on which said extended portion is not formed toward said extended portion side and within the region of said extended portion.

9. A liquid crystal display comprising:
a first substrate on which a first electrode for driving liquid crystal is formed;
a second substrate on which a second electrode for driving liquid crystal is formed; and
a liquid crystal layer held between said first substrate and said second substrate;
wherein at least one substrate of said first substrate and said second substrate is a plastic substrate;
and wherein a hole serving as a liquid crystal inlet passing through at least one substrate of said first substrate and said second substrate is formed on the substrate.

10. A liquid crystal display according to claim 9, wherein said hole is formed within a region of 1 mm or less in the inner side direction of the substrate on which said hole is formed from the end edge of said liquid crystal inlet side.

11. A method for manufacturing a liquid crystal display comprising a step for gluing a first substrate on which an electrode for driving liquid crystal is formed and a second substrate on which an electrode for driving liquid crystal is formed through a seal member which is formed on a portion other than a portion serving as a liquid crystal inlet, and then forming panels by cutting out said glued first and second substrates employing laser cutting;
wherein at least one substrate of said first substrate and said second substrate is a plastic substrate;
and wherein a hole serving as a liquid crystal inlet is formed in at least one substrate of said first substrate and said second substrate for passing through the substrate prior to gluing said first substrate and said second substrate;
and wherein said first substrate and said second substrate are cut out so as to exclude said hole.

12. A method for manufacturing a liquid crystal display according to claim 11;
wherein an extended portion extruding toward outside of said first substrate and said second substrate is formed;
and wherein, in the substrate end edge on which said extended portion is formed, said hole is formed within a region of 1 mm or less in the inner side direction of the substrate from a line extending from the end edge of the portion on which said extended portion is not formed toward said extended portion side within the region of said extended portion.

13. A method for manufacturing a liquid crystal display according to claim 11, wherein said hole is formed within a region of 1 mm or less in the inner side direction of the substrate on which said hole is formed, from the end edge of said liquid crystal inlet side.
